(19) United States
(12) Patent Application Publication
(10) Pub. No.: US 2014/0304238 A1
(43) Pub. Date: Oct. 9, 2014

(54) METHOD AND APPARATUS FOR DETECTING DUPLICATE MESSAGES

(71) Applicant: NOKIA CORPORATION, Espoo (FI)

(72) Inventors: Tero Mikael Halla-Aho, Oulu (FI); Yongbeom Pak, Espoo (FI); Srikanth Kyatham, Espoo (FI); Eero Tapani Lepisto, Espoo (FI)

(73) Assignee: Nokia Corporation, Espoo (FI)

(21) Appl. No.: 13/857,769

(22) Filed: Apr. 5, 2013

(51) Int. Cl. G06F 17/30

(52) U.S. Cl. CPC G06F 17/30156
USPC 707/692

(57) ABSTRACT

An approach is provided for detect duplicate messages with multiple probabilistic data structures. A de-duplication platform causes, at least in part, a representing of one or more messages in two or more probabilistic data structures. The de-duplication platform further causes, at least in part, an alternating clearing of the two or more probabilistic data structures as respective probabilistic data structures are filled with the one or more messages to respective thresholds, with the two or more probabilistic data structures facilitating determination of one or more duplicates among the one or more messages.

### BACKGROUND

Service providers and device manufacturers (e.g., wireless, cellular, etc.) are continually challenged to deliver value and convenience to consumers by, for example, providing compelling network services. Such compelling network services include providing messages to consumers, such as emails, short message service (SMS) messages, and multimedia messaging service (MMS) messages, instant messages (IMs), as well as messages in the form of notifications, such as push notifications. However, there may be situations where a consumer receives the same message more than once (e.g., duplicate messages). Although conventional techniques of storing the messages may allow for detection of duplicates, such techniques result in large data structures that may decrease performance of features related to the messages and increase memory consumption. Further, such conventional techniques cannot be implemented in, for example, devices that have minimal device resources, such as memory. Accordingly, service providers and device manufacturers face significant technical challenges associated with providing messages without duplication.

### SOME EXAMPLE EMBODIMENTS

Therefore, there is a need for an approach for detecting duplicate messages using two or more probabilistic data structures. Such an approach can be implemented in, for example, devices that have minimal device resources.

According to one embodiment, a method comprises causing, at least in part, a representing of one or more messages in two or more probabilistic data structures. The method also comprises causing, at least in part, an alternating clearing of the two or more probabilistic data structures as respective probabilistic data structures are filled with the one or more messages to respective thresholds, wherein the two or more probabilistic data structures facilitate determination of one or more duplicates among the one or more messages.

According to another embodiment, an apparatus comprises at least one processor, and at least one memory including computer program code for one or more computer programs, the at least one memory and the computer program code configured to, with the at least one processor, cause, at least in part, the apparatus to represent one or more messages in two or more probabilistic data structures. The apparatus is also caused to alternate clearing of the two or more probabilistic data structures as respective probabilistic data structures are filled with the one or more messages to respective thresholds, wherein the two or more probabilistic data structures facilitate determination of one or more duplicates among the one or more messages.

According to another embodiment, a computer-readable storage medium carries one or more sequences of one or more instructions which, when executed by one or more processors, cause, at least in part, an apparatus to represent one or more messages in two or more probabilistic data structures. The apparatus is also caused to alternate clearing of the two or more probabilistic data structures as respective probabilistic data structures are filled with the one or more messages to respective thresholds, wherein the two or more probabilistic data structures facilitate determination of one or more duplicates among the one or more messages.

According to another embodiment, an apparatus comprises means for causing, at least in part, a representing of one or more messages in two or more probabilistic data structures. The apparatus also comprises means for causing, at least in part, an alternating clearing of the two or more probabilistic data structures as respective probabilistic data structures are filled with the one or more messages to respective thresholds, wherein the two or more probabilistic data structures facilitate determination of one or more duplicates among the one or more messages.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of detecting duplicate messages, according to one embodiment;

FIG. 2 is a diagram of the components of a de-duplication platform, according to one embodiment;

FIG. 3 is a flowchart of a process for detecting duplicate messages using two or more probabilistic data structures, according to one embodiment;

FIG. 4 is a flowchart of a process for populating two or more probabilistic data structures, according to one embodiment;

FIG. 5 is a flowchart of a process for representing messages in two or more probabilistic data structures, according to one embodiment;

FIG. 6 is an illustration of a process for representing messages in two or more probabilistic data structures, according to one embodiment;

FIG. 7 is a flowchart of a process for processing an identifier of a message to detect duplicate messages, according to one embodiment;

FIG. 8 is an illustration of a process for processing an identifier of a message to detect duplicate messages, according to one embodiment;

FIGS. 9A-9I are diagrams of exemplary probabilistic data structures utilized in detecting duplicate messages, according to one embodiment;

FIG. 10 is a diagram of hardware that can be used to implement an embodiment of the invention;

FIG. 11 is a diagram of a chip set that can be used to implement an embodiment of the invention; and

FIG. 12 is a diagram of a mobile terminal (e.g., handset) that can be used to implement an embodiment of the invention.

### DESCRIPTION OF SOME EMBODIMENTS

Examples of a method, apparatus, and computer program for detecting duplicate messages are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to Bloom filters as exemplary probabilistic data structures, it is contemplated that the approach described herein may be used with any probabilistic data structure that provides for the ability to determine the probability that an entity is a member of a group of entities, such as whether a message is a member of a group of messages.

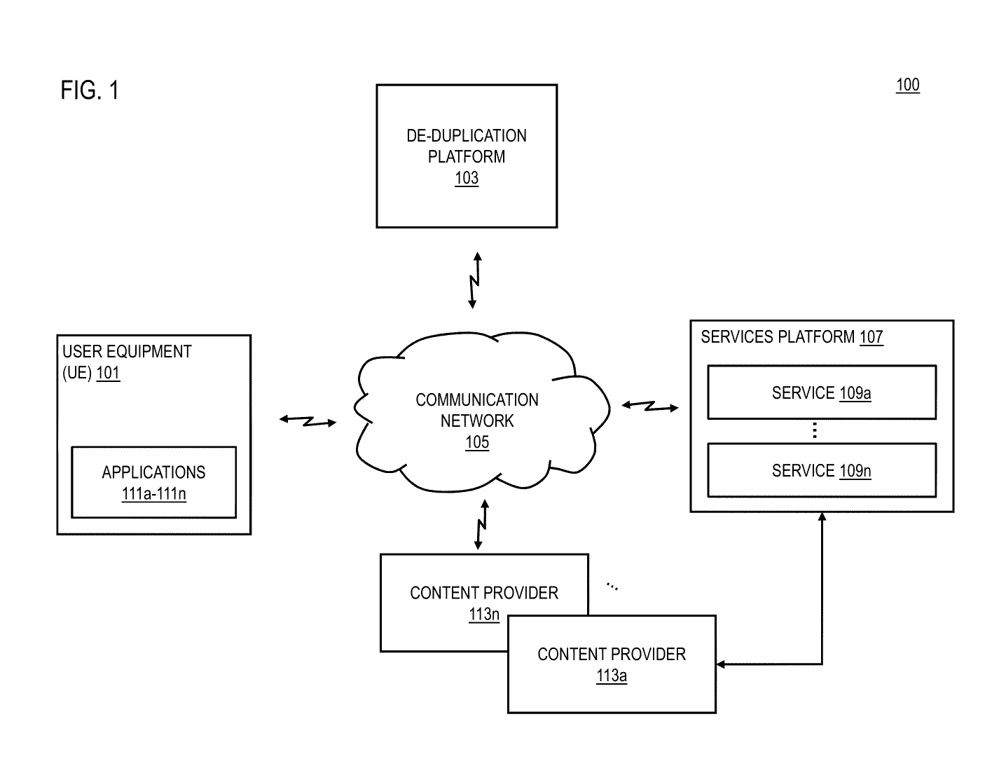

FIG. 1 is a diagram of a system 100 capable of detecting duplicate messages using two or more probabilistic data structures, according to one embodiment. As discussed above, service providers and device manufacturers provide many services to forward messages to consumers. Such messages may be, for example, emails, SMS messages, MMS messages, IMs, etc. Further, such messages may be notifications, such as push notifications, associated with one or more applications or regarding and/or associated with emails, SMS messages, MMS messages, IMs, etc. (e.g., associated with other messages). However, there may be situations where a consumer receives the same message more than once (e.g., duplicate emails or SMS messages, or duplicate push notifications). By way of example, there may be situations with respect to push notifications where a client may receive the same notification more than once. Receiving the duplicate messages leads to a bad consumer experience. Accordingly, service providers and device manufactures face significant technical challenges in detecting and preventing duplicate messages. Such technical challenges are even further complicated when associated with devices that have limited resources, such as limited processing power, memory and storage space.

To address these problems, a system 100 of FIG. 1 introduces the capability to detecting duplicate messages using two more probabilistic data structures, such as Bloom filters. The probabilistic data structures, such as Bloom filters, are a space-efficient way of keeping track of unique items. The probabilistic data structures can be controlled with respect to, for example, their size, their number and their capacity to include representations of items in them and then verify whether an item is previously known or not. Applied to messages, one or more messages are represented in the two or more probabilistic data structures, which are then used to determine one or more duplicates among the one or more messages. By using two or more probabilistic data structures, one probabilistic data structure may be cleared while maintaining the representations of one or more messages in the remaining probabilistic data structures. Accordingly, the remaining probabilistic data structures may be used in determining duplicate messages despite the one probabilistic data structure being cleared. The probabilistic data structures may then be sequentially cleared as respective probabilistic data structures reach a threshold, such as a threshold capacity. Such a threshold capacity may be based on the number of messages that may be represented within the probabilistic data structures. Further, upon detecting duplicate messages, the system 100 can then handle the duplicates such that the user of a device that receives or would otherwise be notified of the duplicates is unaware of the duplicates.

As shown in FIG. 1, the system 100 comprises a user equipment (UE) 101 having connectivity to a de-duplication platform 103 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, near field communication (NFC), Internet Protocol (IP) data casting, digital radio/television broadcasting, satellite, mobile ad-hoc network (MANET), and the like, or any combination thereof.

The UE 101 is any type of mobile terminal, fixed terminal, or portable terminal including a mobile handset, station, unit, device, mobile communication device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

The UE 101 may include one or more applications 111a-111n (collectively referred to as applications 111). The applications 111 may be any type of application, such as a one or more communication applications, including email applications, SMS/MMS message applications, IM applications, or any other messaging applications. The applications 111 may allow for one or more messages to be received at the UE 101, such emails, SMS, MMS, IMs, etc. The applications 111 may include other types of applications, such as mapping applications, navigation applications, weather applications, news application, Internet browsing applications, etc. that may provide one or more messages to the user of the UE 101, such as push notifications. In one embodiment, the operating system of the UE 101 may be considered an application 111 that may generate one or more messages, such as notifications, that are displayed on a user interface of the UE 101. By way of example, the operating system may display a message, such as a notification, upon the UE 101 receiving one or more other messages (e.g., emails, SMS, MMS, IMs, etc.). These messages notify the user that the one or more other messages have been received for the user to view.

In one embodiment, one or more of the applications 111 may interface with the de-duplication platform 103 (discussed below) for detecting and handling one or more duplicate messages. For example, an email application may interface with the de-duplication platform 103 to determine whether an email received and waiting for download from an email server is a duplicate of an email already received or already downloaded from the email server. By way of another example, a push notification stack associated with an application 111 may interface with the de-duplication platform 103 for determining whether a message (e.g., notification) is a duplicate of a previous message (e.g., previous notification). In one embodiment, one of the applications 111 may incorporate all of the functions and/or operations of the de-duplication platform 103 and/or act as an interface (e.g., client) between the de-duplication platform 103 and the UE 101 and/or applications 111 for detecting and eliminating duplicate messages.

In one embodiment, the system 100 may include one de-duplication platform 103 that detects for duplicates of different types of messages, such as one de-duplication platform 103 for emails, SMS, MMS, IMs, push notifications, etc. In one embodiment, each different type of message may be associated with a different de-duplication platform 103. For example, there may be separate de-duplication platforms 103 for handling emails, SMS and push notifications.

The system 100 further includes a services platform 107. The services platform 107 provides one or more services 109a-109n (collectively referred to as services 109) to the system 100. In one embodiment, the services 109 may be associated with providing one or more messages at the UE 101, such as one or more communication services associated with transmitting emails, SMS messages, MMS messages, IMs, etc. By way of another example, the one or more services 109 may be associated with one or more applications 111 executed at the UE 101, such as one or more services 109 related to a navigation application, a calendar application, a mapping application, etc. In one embodiment, these services 109 may provide one or more messages at the UE 101, such as one or more push notifications associated with news, sports, weather, etc. Further, in one embodiment, one or more of the services 109 and/or the services platform 107 may be associated with providing probabilistic data structures, such as Bloom filters, for one or more operations associated with the system 100, such as for use by the de-duplication platform 103 and/or the UE 101. Further, although only one services platform 107 is illustrated, the system 100 may include more than one services platform 107 that provides similar or different services.

The system 100 further includes one or more content providers 113a-113n (collectively referred to as content providers 113). The content providers 113 may provide various content to the elements of the system 100. Such content may be related to one or more applications 111, one or more services 109 or providing one or more probabilistic data structures, such as Bloom filters.

The de-duplication platform 103 provides for detecting duplicate messages by using two or more probabilistic data structures. As discussed above, the de-duplication platform 103 can cause a representing of one or more messages in two or more probabilistic data structures. The messages may be represented by processing the messages by one or more hash functions associated with one or more of the probabilistic data structures to change a value of one or more bits within a bit array associated with the one or more of the probabilistic data structures. Specifically, identifiers associated with the messages are processed by one or more hash functions. The hash functions may be any type of algorithm and/or subroutine that can map an identifier of a variable length to a smaller data set of a fixed length. Upon processing the identifiers, the outputs of the hash functions are stored in one or more bits within bit arrays of the probabilistic data structures. By way of example, an identifier processed with respect to a hash function may result in a specific bit within a bit array of a probabilistic data structure having a value changed from 0 to 1. Thus, the 1 for the specific bit within the bit array of the probabilistic data structure is a representation of the message. However, the representation may take other forms, such as a having more than one bit within the bit array have a value changed from 0 to 1 (e.g., two or more bits) with respect to a single identifier processed by a single hash function.

The identifiers associated with the messages may be any unique identification format or approach that allows for identifying duplicate messages. By way of example, where the messages constitute push notifications, the push notification internal protocol contains a notification identifier that is an identification for each notification (e.g., message) that is sent from an application programming interface (API) to a push notification API client. Such an identification can be used as the identifier of the message. However, other identifiers may be used, such as identifiers with respect to emails, SMS messages, MMS messages, IMs, etc. where the identifiers allow for unique identification of the messages.

In one embodiment, where a single de-duplication platform 103 handles more than one type of message, and where the identifiers for the different types of messages are not uniform, the de-duplication platform 103 may use different sets of two or more probabilistic data structures for each type of message. For example, emails may be associated with one set of two or more probabilistic data structures, SMS messages may be associated with a different set of two or more probabilistic data structures and push notifications may be associated with a different set of two or more probabilistic data structures.

All probabilistic data structures have a capacity for storing representations of messages that is based on the ability to accurately detect whether an item is a member of a group of items. By way of example, for a bit array of 15 bits that store values of either 0 or 1, once all of the bits are filled with values of 1, the probabilistic data structure can theoretically hold more representations (e.g., change bit values already 1 to 1). However, the bit array can no longer be used to determine, for example, duplicates because the values of the bits will always be 1 no matter if a message is a duplicate or not. Thus, a threshold capacity can be established for the probabilistic data structures that considers the number of representations of messages that are stored versus the ability to accurately detect duplicate messages. In one embodiment, such a threshold capacity can be set by a user of the UE 101 at a client application. In one embodiment, such a threshold capacity may be set by a service provider associated with the de-duplication platform 103 at a backend server. Further, other characteristics of the probabilistic data structures may be set at either the client or the backend server, such as the number of probabilistic data structures that are used for detecting duplicates and the size (e.g., number of bits within the bit array) for each probabilistic data structure.

When the two or more probabilistic data structures reach their respective threshold capacities and another representation of a message must be stored, less than all of the probabilistic data structures are cleared. Because less than all of the probabilistic data structures are cleared, the probabilistic data structures that are not cleared may be used to determine duplicate messages. Thus, the de-duplication platform 103 can cause, at least in part, an alternating clearing of the two or more probabilistic data structures as respective probabilistic data structures are filled with the one or more messages to respective threshold capacities. By way of example, as two probabilistic data structures are filled to their respective threshold capacities with representations, one of the probabilistic data structures may be cleared while the other is not cleared. Thus, the one that is not cleared may be used to detect duplicate messages. Where more than two probabilistic data structures are used, such as four, one or more may be cleared, such as two, while the other probabilistic data structures (e.g., other two) are not cleared and used to detect duplicate messages. Moreover, the de-duplication platform 103 can cause, at least in part, a counting of the one or more messages that are represented in the two or more probabilistic data structures to determine when the threshold capacities are reached. When the threshold capacities are reached, the de-duplication platform 103 can cause a clearing of the probabilistic data structures according to the alternating order.

Once the one or more probabilistic data structures that are cleared are again at their respective capacities, the de-duplication platform 103 can clear the other (e.g., alternating) probabilistic data structures. By way of example, for two probabilistic data structures, after the first probabilistic data structure is cleared and again full, the de-duplication platform 103 can clear the second probabilistic data structure. Thus, the alternating clearing is alternating clearing between at least one of the two or more probabilistic data structures as at least another of the two or more probabilistic data structures is filled to the respective threshold.

By way of example, the UE 101, the de-duplication platform 103, the services platform 107, and the content providers 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

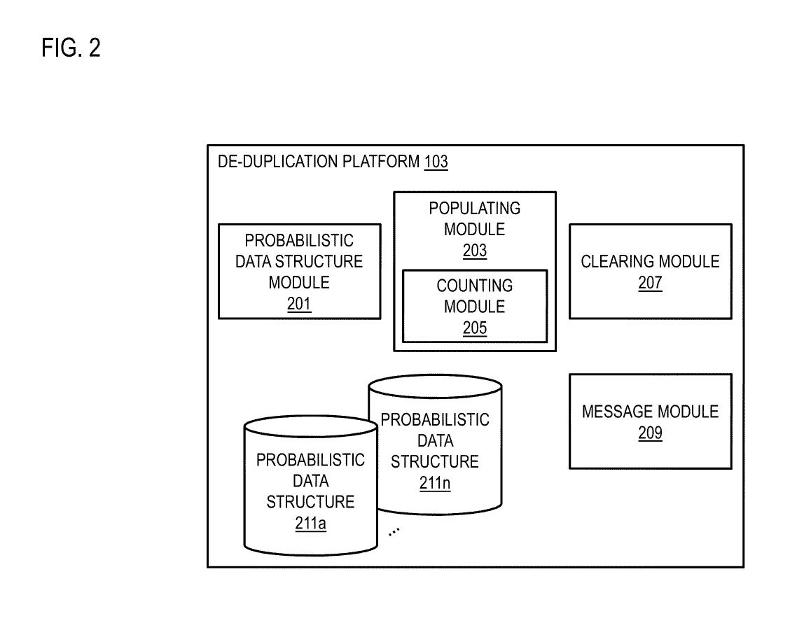

FIG. 2 is a diagram of the components of a de-duplication platform 103, according to one embodiment. By way of example, the de-duplication platform 103 includes one or more components for detecting duplicate messages. It is contemplated that the functions of these components may be combined in one or more components or performed by other components of equivalent functionality. By way of example, the de-duplication platform 103 may be embodied in an application 111 executed at the UE 101, such as a push notification client, or may be embodied in one or more services 109 and/or as a standalone element within the system 100.

In this embodiment, the de-duplication platform 103 includes a probabilistic data structure module 201, a populating module 203, a counting module 205, a clearing module 207, a message module 209 and probabilistic data structures 211a-211n.

The probabilistic data structure module 201 determines the characteristics associated with the probabilistic data structures for representing messages. For example, the probabilistic data structure module 201 may determine the number of probabilistic data structures that are used, such as two Bloom filters. In one embodiment, upon determining the number of probabilistic data structures that are used, the probabilistic data structure module 201 may create the probabilistic data structures, such as probabilistic data structures 211a-211n, and/or access one or more probabilistic data structures that fit the determined requirements, such as from one or more services 109 and/or content providers 113 that provide probabilistic data structures. Further, the probabilistic data structure module 201 may determine the size of the bit array (e.g., the number of bits) for each of the probabilistic data structures. In one embodiment, the probabilistic data structure module 201 may further determine the threshold capacity of the probabilistic data structures. The size of the bit array and the threshold capacity may be determined based on, for example, one or more algorithms and/or formulas associated with creating probabilistic data structures, and may include a desired probability associated with an accurate determination of a duplicate message.

Further, the probabilistic data structure module 201 may determine the number of hash functions that map and/or hash the identifiers associated with the messages to the bits of the bit array. In one embodiment, the probabilistic data structure module 201 may also determine the specific algorithms and/or formulas that are used for the hash functions, such as selecting a determined number of hash functions from a set of hash functions. In one embodiment, the probabilistic data structure module 201 may determine the number of hash functions that are to be used and a human operator may define or provide the specific hash functions.

The populating module 203 populates the probabilistic data structures with the representations of the identifiers of the messages. Thus, the populating module 203 processes the identifiers with respect to the hash functions to determine the bits of the bit array and the corresponding values. In one embodiment, the values of the bits in the bit array are 0 or 1. However, any method may be used with respect to the hash functions and bits within the bit array to represent an identifier of a message within a probabilistic data structure. In one embodiment, the populating module 203 populates one probabilistic data structure with representations of the identifiers of the messages until the one probabilistic data structure reaches the threshold capacity. The populating module 203 then populates another probabilistic data structure with representations of identifiers of messages until the other probabilistic data structure reaches the threshold capacity. The populating module 203 may continue populating representations of identifiers of messages within the probabilistic data structures until the probabilistic data structures reach the threshold capacity in such an alternating fashion until all of the probabilistic data structures are filled. Subsequently, the process may be repeated as probabilistic data structures are cleared. In one embodiment, the populating module 203 may populate two or more probabilistic data structures in various other methods. With respect to four probabilistic data structures, the populating module 203 may populate representations of identifiers of messages between two probabilistic data structures, alternating between the two for each representation, until the two probabilistic data structures reach a threshold capacity. Then, the populating module 203 may populate representations of identifiers of messages between the other two probabilistic data structures, alternating between the two for each representation, until the two other probabilistic data structures reach threshold capacities.

In one embodiment, the populating module 203 may include a counting module 205. However, in other embodiments, the counting module 205 may be a separate module within the de-duplication platform 103. The counting module 205 may count each time a message is represented within a probabilistic data structure. Accordingly, the counting module 205 may be used to determine when the probabilistic data structures reach their respective threshold capacities. When the probabilistic data structures are cleared, the counting module 205 may reset the corresponding counters.

The clearing module 207 clears the probabilistic data structures once they reach the threshold capacities. In one embodiment, the clearing may occur once a probabilistic data structure reaches the threshold capacity. In one embodiment, the clearing may occur once all of the probabilistic data structures reach their respective threshold capacities. Further, one or more probabilistic data structures may be cleared at a single time. By way of example, for two probabilistic data structures, one probabilistic data structure may be cleared once both probabilistic data structures reach their respective capacities. The probabilistic data structure that cleared may alternate. By way of another example, for four probabilistic data structures, one probabilistic data structure may be cleared once all four probabilistic data structures reach their respective capacities. The specific probabilistic data structure that is cleared may alternate between the four probabilistic data structures as the cleared probabilistic data structure again reaches its respective threshold capacity. Alternatively, for four probabilistic data structures, two probabilistic data structures may be cleared at a time when all four probabilistic data structures reach their respective threshold capacities. The two probabilistic data structures that are cleared may alternate between the four probabilistic data structures one at a time or two at a time.

The message module 209 compares the identifiers of messages received at the de-duplication platform 103 with the representations stored within the probabilistic data structures to determine if an identifier, and therefore a message, is a duplicate on another message. The message module 209 processes the identifier with respect to the hash functions that were used to populate the probabilistic data structures. If the results of the hash functions all come back positive (e.g., 1), then the message may be a member of a set of messages that have already been received, downloaded, opened, etc. If any one or more of the results of the hash functions come back negative (e.g., 0), then the message definitely is not a member of such a set. When the message definitely is not a member of such a set, the message may be, for example, downloaded to the UE 101 that the message was originally intended for, such as in the case of an email, or the message may be displayed at the UE 101 associated with the message, such as in the case of notification. When the message may be a member of the set, the message may be handled such that the user of a UE 101 that was an intended recipient of the message is not notified of the possibly duplicate message, such as by deleting the message, not downloading the message to the UE 101, not notifying regarding the message, etc.

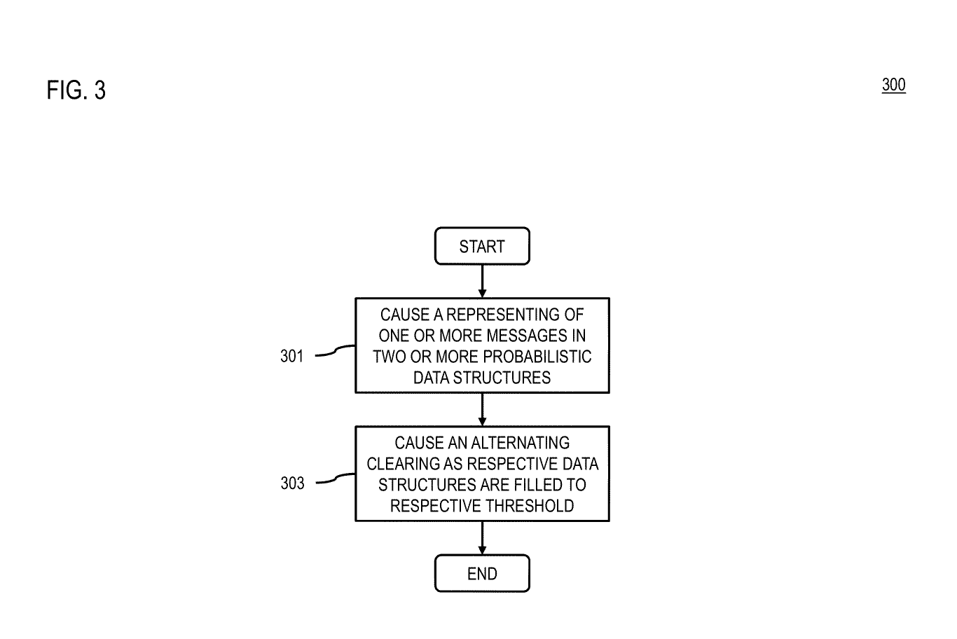

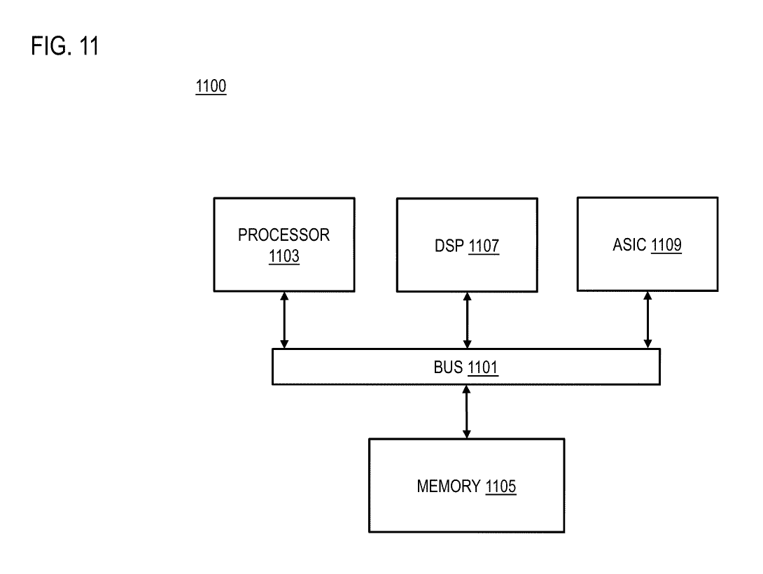

FIG. 3 is a flowchart of a process for detecting duplicate messages, according to one embodiment. In one embodiment, the de-duplication platform 103 performs the process 300 and is implemented in, for instance, a chip set including a processor and a memory as shown in FIG. 11. In step 301, the de-duplication platform 103 causes, at least in part, a representing of one or more messages in two or more probabilistic data structures. The messages are represented by processing identifiers associated with the messages with respect to one or more hash functions. The results of the hash functions are to change a value of a bit associated with a bit array constituting at least part of a probabilistic data structure to represent the message. Depending on the characteristics of the probabilistic data structures, the identifier of the message may be processed by multiple hash functions. By way of example, where each probabilistic data structure has a threshold capacity of 100 representations of messages, with a probability for false positives of 1% and 959 bits in each bit array, seven hash functions are used.

In one embodiment, where the probabilistic data structures are initially empty, one representation of a message may be populated into one of the probabilistic data structures. That probabilistic data structure may then be filled to a threshold capacity with additional representations. When another message is to be represented, another probabilistic data structure may be populated with the representation. Such a process may proceed until all of the probabilistic data structures are populated to their respective threshold capacities.

Then, in step 303, the de-duplication platform 103 causes, at least in part, an alternating clearing of the two or more probabilistic data structures. The alternating clearing always leaves at least one probabilistic data structure that is filled with representations of message that can be used to detect duplicate messages. By way of example, the first probabilistic data structure that may be cleared is the probabilistic data structure with the oldest representation of a message, such as a message that has the oldest received date and/or transmission date. This probabilistic data structure may be cleared first because, for example, the likelihood of receiving a duplicate of the oldest message is less than the likelihood of receiving a duplicate of a newer message. Once the probabilistic data structure is cleared, the probabilistic data structure may again receive new representations of messages. Upon the probabilistic data structure reaching its threshold capacity again, another of the two or more probabilistic data structures may be cleared, such as the probabilistic data structure that now has the oldest representation of a message.

Where there are more than two probabilistic data structures, such as six probabilistic data structures, more than one probabilistic data structure may be cleared at a time. For example, two probabilistic data structures may be cleared and four may remain not cleared. The four that remain not cleared may be used to detect duplicate messages. The two that are cleared may be the two that have the oldest representations of messages. When the two probabilistic data structures are cleared, they may then receive new representations of messages and the process may be repeated when the two probabilistic data structures reach their threshold capacities.

By using two or more probabilistic data structures as way of determining duplicate messages, and clearing less than all of the two or more probabilistic data structures, the remaining probabilistic data structures that are not cleared may be used to determine one or more duplicate messages while the other probabilistic data structures that are cleared are empty. As the probabilistic data structures that are cleared are re-populated with representations of messages, all of the probabilistic data structures may be used to determine duplicate messages. Accordingly, duplicate messages received by the user of a UE 101 can be reduced or eliminated, thereby reducing or eliminating the negative results of duplicate messages at the UE 101.

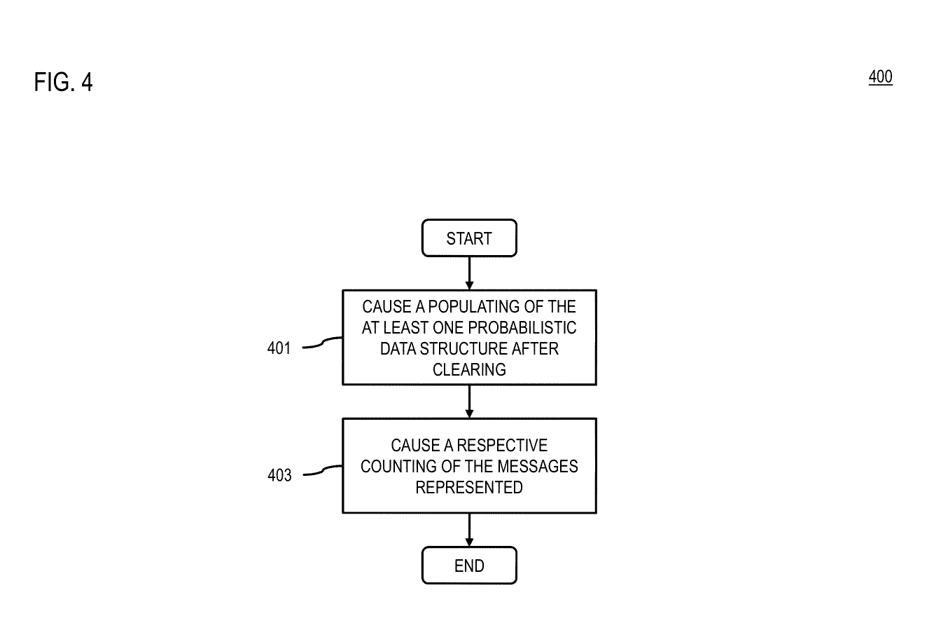

FIG. 4 is a flowchart of a process for populating two or more probabilistic data structures, according to one embodiment. In one embodiment, the de-duplication platform 103 performs the process 400 and is implemented in, for instance, a chip set including a processor and a memory as shown in FIG. 11. In step 401, the de-duplication platform 103 causes, at least in part, a populating of the at least one of the two or more probabilistic data structures. The populating may be one probabilistic data structure at a time, such as until the probabilistic data structure reaches a threshold capacity. The populating may also be more than one probabilistic data structure at a time. For example, in one embodiment, there may be four probabilistic data structures. Two of the probabilistic data structures may be populated at the same time alternating between the two. When the two probabilistic data structures are populated to their respective capacities, the other two probabilistic data structures may be populated, such as when the four probabilistic data structures are initially populated with representations of messages. Thus, the two or more probabilistic data structures may be populated according to various different processes to their respective threshold capacities. Further, as all of the probabilistic data structures are filled to their respective capacities, the same process may repeat for populating the probabilistic data structures after clearing one or more structures data structures.

In step 403, as the probabilistic data structures are populated, the de-duplication platform 103 may case, at least in part, a respective counting of the one or more messages represented in the two or more probabilistic data structures. The counting occurs such that the de-duplication platform 103 can determine when the probabilistic data structures reach their respective capacity. By way of example, with two probabilistic data structures each having a capacity of 100 representations of messages, as each identifier associated with each message is processed and represented within a probabilistic data structure, a counter associated with the probabilistic data structure increases by 1 until the counter reaches the threshold capacity of 100. When both probabilistic data structures reach their respective capacities of 100, one of the probabilistic data structures can be cleared, as discussed above, to again be populated until the threshold capacity is reached.

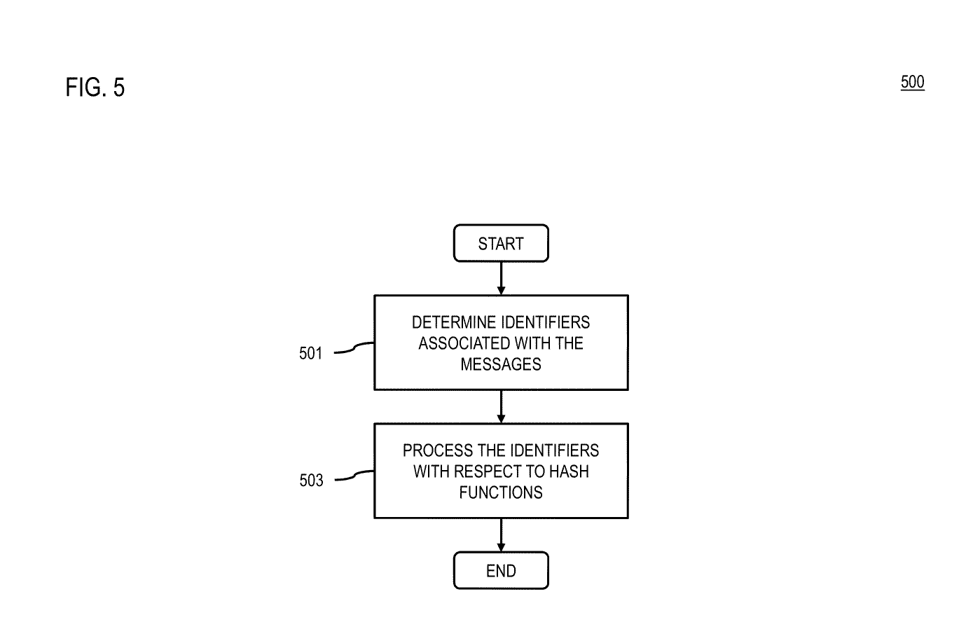

FIG. 5 is a flowchart of a process for representing messages in two or more probabilistic data structures, according to one embodiment. In one embodiment, the de-duplication platform 103 performs the process 500 and is implemented in, for instance, a chip set including a processor and a memory as shown in FIG. 11. In step 501 the de-duplication platform 103 determines one or more identifiers associated with one or more messages. The messages may be received at the UE 101 or at the de-duplication platform 103, such as where the messages are intended for the UE 101 but are received by the de-duplication platform 103 prior to reaching the UE 101. In one embodiment, the UE 101 and/or the de-duplication platform 103 may receive one or more indications that the one or more messages are waiting for transmission to the UE 101. Further, the one or more messages may be any type of communication, such as an email, an SMS message, an MMS message, IMs, or other proprietary communication. Further, the one or more messages may include notifications, such as notifications that one or more messages may be received and/or downloaded to the UE 101. Further, the one or more messages may include one or more identifiers that uniquely identify the messages. By way of example, a push notification internal protocol contains an identifier associated with a message that may be used as the identifier in step 501. However, the identifier that is used may be any type and/or format that allows for unique identification of the message among the same type of message. For example, an identifier for push notifications need not be the same format and/or type as the identifier for an email message, where the probabilistic data structures are different for the two messages.

At step 503, the de-duplication platform 103 processes and/or facilitates a processing of the one or more identifiers with respect to one or more hash functions of two or more probabilistic data structures to cause, at least in part, a representing of the one or more messages. The hash functions are any algorithm and/or subroutine that map large data sets of variable length to smaller data sets of fixed length. By way of example, a hash function may map an identifier of a variable length to one of a plurality of bits of a bit array and change the value of the bit to 1 rather than 0. Accordingly, the identifier is represented within the bit array by the bit having a value of 1. The number of hash functions used may be based on desired characteristics of the probabilistic data structure, such as the threshold capacity, the number of bits, and the probability of having an inaccurate determination of a duplicate message. The combination of the values resulting from the hash functions saved within a bit array of a probabilistic data structure represents the representations of the one or more messages within the two or more probabilistic data structures.

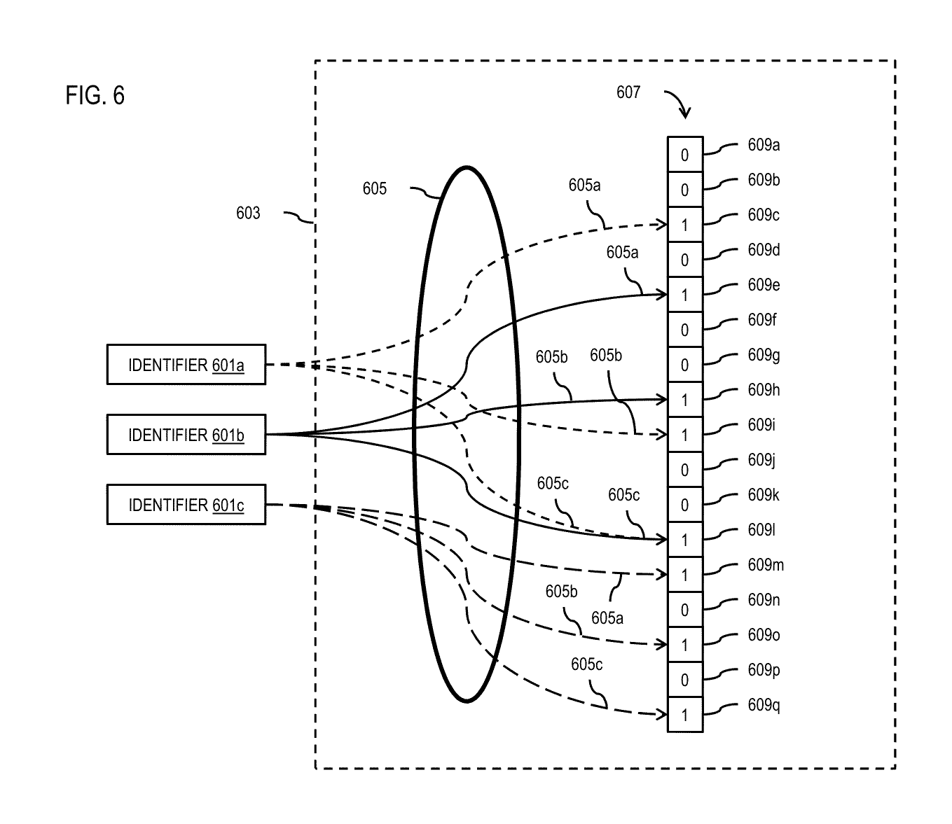

FIG. 6 is an illustration of a process for representing messages in two or more probabilistic data structures, according to one embodiment. One or more messages may be represented within the probabilistic data structure 603 based on the associated identifiers 601a-601c of the messages being processed by one or more hash functions. As illustrated in FIG. 6, the probabilistic data structure 603 includes three hash functions 605a-605c and a bit array 607. The hash functions 605a-605c are any algorithms or subroutines that map large data sets of variable length to smaller data sets of a fixed length. As illustrated, the hash functions 605a-605c process the identifiers 601a-601c into 0 or 1 values that are stored in the bit array 607. The bit array 607 includes bits 609a-609q that store the 0 or 1 values. As illustrated, the identifier 601a is processed by hash functions 605a-605c and a value of 1 is stored in bits 609c, 609i and 609l, respectively. Similarly, the identifier 601b is processed by hash functions 605a-605c and a value of 1 is stored in bits 609e, 609h and 609l. Further, the identifier 601c is processed by hash functions 605a-605c and a value of 1 is stored in bits 609m, 609o and 609q. Accordingly, the algorithms of the hash functions 605a-605c determine the bits 609 in the bit array 607 where the values are changed from 0 to 1 to indicate representations of the messages corresponding to the identifiers 601a-601c.

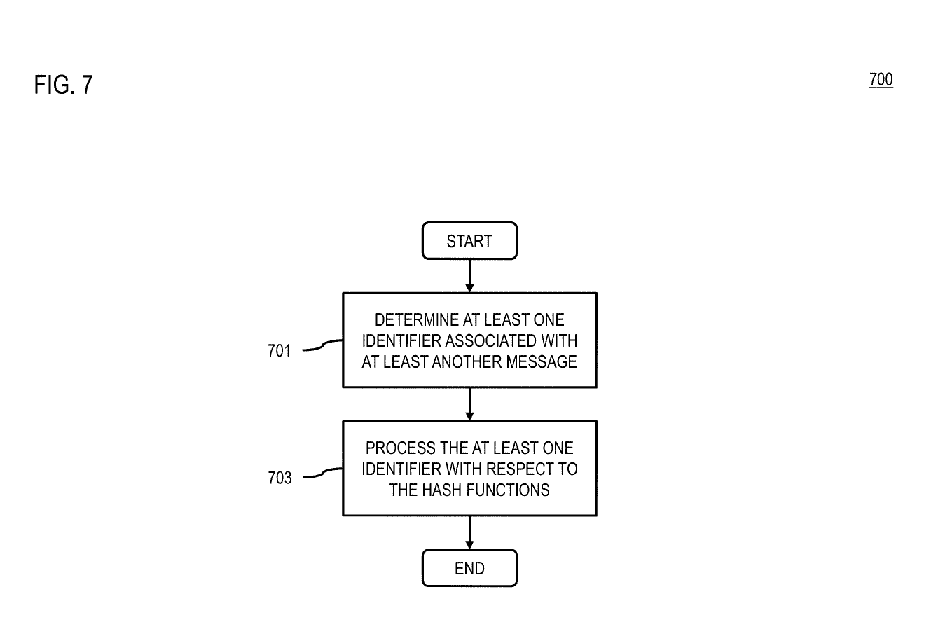

FIG. 7 is a flowchart of a process for processing an identifier of a message to detect duplicate messages, according to one embodiment. In one embodiment, the de-duplication platform 103 performs the process 700 and is implemented in, for instance, a chip set including a processor and a memory as shown in FIG. 11. In step 701, the de-duplication platform 103 determines at least one identifier associated with at least another message. The other message may be received at the UE 101 or at the de-duplication platform 103, such as where the other message is intended for the UE 101 but is received by the de-duplication platform 103 prior to reaching the UE 101. In one embodiment, the UE 101 and/or the de-duplication platform 103 may receive an indication that the other message is waiting for transmission to the UE 101.

As discussed above, regardless of the status of the other message, the other message is associated with at least one identifier. The identifier may be any identifier that is associated with and uniquely identifies the other message. By way of example, a push notification internal protocol contains an identifier associated with a message that may be used as the identifier in step 701, where the message is a push notification.

At step 703, the de-duplication platform 103 processes and/or facilitates a processing of the at least one identifier with respect to one or more hash functions associated with two or more probabilistic data structures to determine whether the at least another message is a duplicate of the one or more messages. The one or more hash functions are the same hash functions that are used to determine and populate representations of the messages within the two or more probabilistic data structures. Upon processing the identifier with respect to the one or more hash functions, the values of the resulting bits are checked to determine whether the values indicate a representation of another message. By way of example, the bits corresponding to the output of the hash functions are determined for whether they have a value of 0 or 1. If at least one of the combinations of the hash functions result in bits with all 1 s (or some other negative indication of a representation) with respect to all of the probabilistic data structures that include a representation of at least one message, then the message may have already been received and/or sent to the UE 101 and/or the de-duplication platform 103 intended for the UE 101. In which case, the message is likely a duplicate of another message. The de-duplication platform 103 and/or the UE 101 may do any action (or inaction) that ignores or otherwise disregards the other message, such as deleting the other message, indicating that the other message was already downloaded and/or received, ignoring the message at a server, etc. If none of the combinations of the hash functions result in bits with all 1 s (or some other negative indication of a representation) with respect to all of the probabilistic data structures that include a representation of at least one message, then the message has definitely not been received and/or sent to the UE 101 and/or the de-duplication platform 103 intended for the UE 101. In which case, the message is not a duplicate and the message can be processed as normal, such as being downloaded to the UE 101 and/or rendered at the UE 101 to notify the user of the UE 101 of the message.

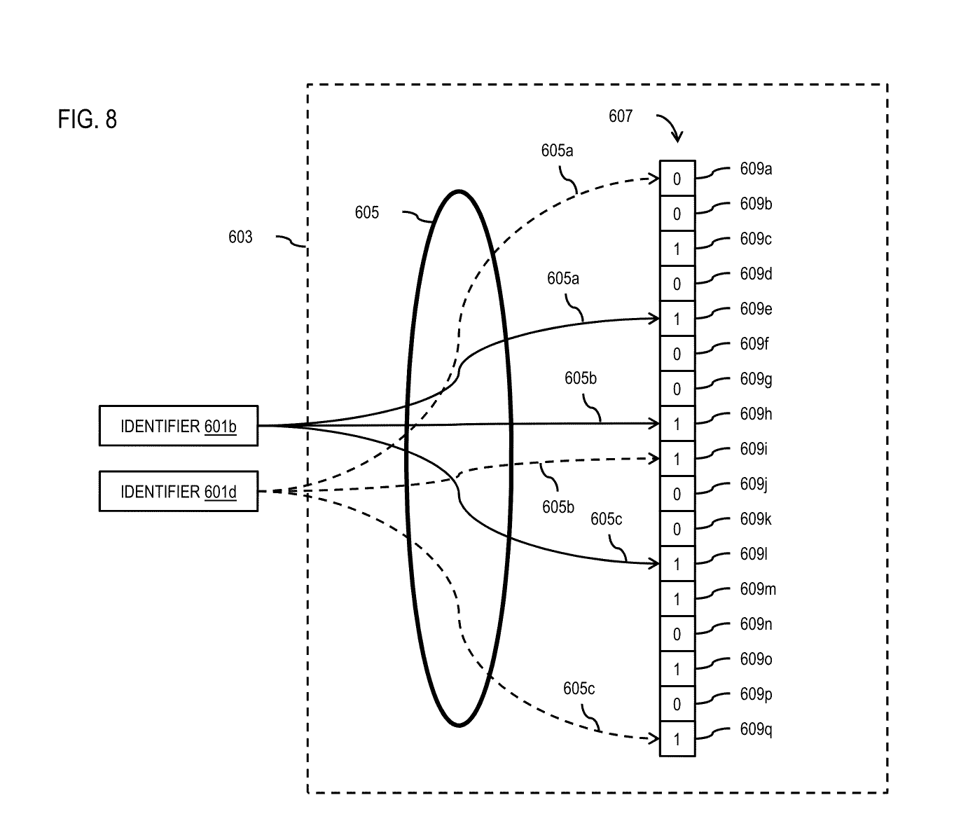

FIG. 8 is an illustration of a process for processing an identifier of a message to detect duplicate messages, according to one embodiment. As illustrated, two identifiers 601b and 601d may be processed with respect to a probabilistic data structure 603 (e.g., same as in FIG. 6). The probabilistic data structure 603 includes the three hash functions 605a-605c and the bit array 607. To determine whether a message associated with an identifier is already represented in the probabilistic data structure 603, the identifiers 601b and 601d are processed by the hash functions 605 and the results are compared to the values of the bits 609 of the bit array 607. Based on the previous example illustrated in FIG. 6, identifier 601b was already represented within the bit array 607. Thus, when the identifier 601b is processed by the hash functions 605, the values of the corresponding bits 609 are all 1. For example, transformation by the hash function 605a of the identifier 601b leads to the bit 609e, which has a value of 1. Likewise, transformation of the identifier 601b by the hash functions 605b and 605c leads to bits 609h and 6091, which also both have values of 1. Accordingly, because all of the hash functions 605 result in bits 609 with a value of 1, the message associated with the identifier 601b is most likely represented already in the probabilistic data structure 603 and, therefore, already received, for example, at the UE 101.

When the identifier 601d is processed by the hash functions 605, the values of the corresponding bits 609 are not all 1. For example, transformation by the hash function 605a of the identifier 601d leads to the bit 609a, which has a value of 0. Likewise, transformation of the identifier 601d by the hash functions 605b and 605c leads to bits 609i and 609q, which both have values of 1. Although two of the three hash functions 605 result in bits 609 with values of 1, because bit 609a has a value of 0, the message associated with the identifier 601d has definitely not been received yet.

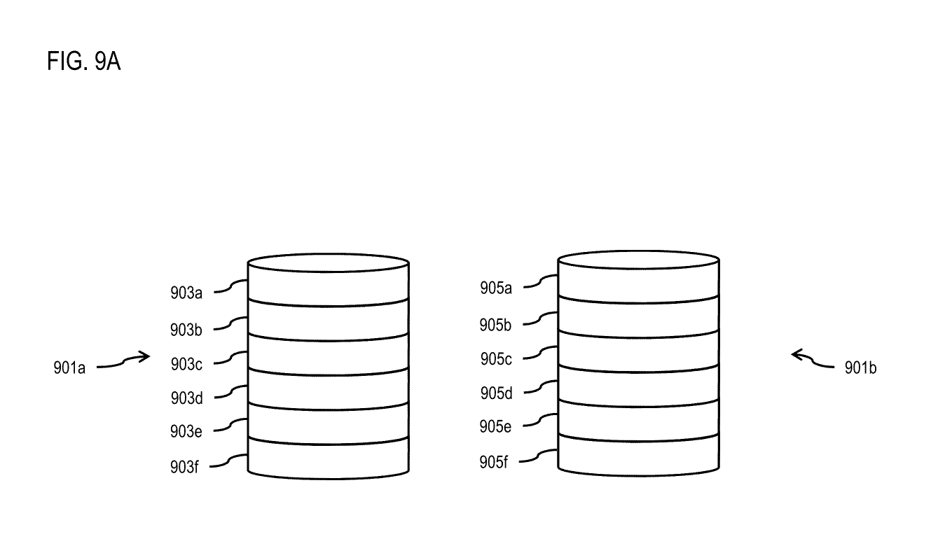

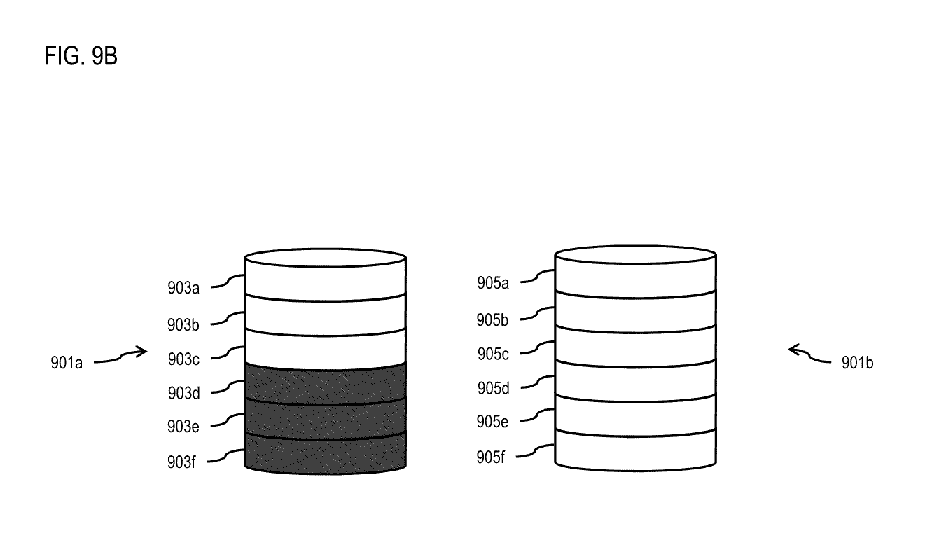

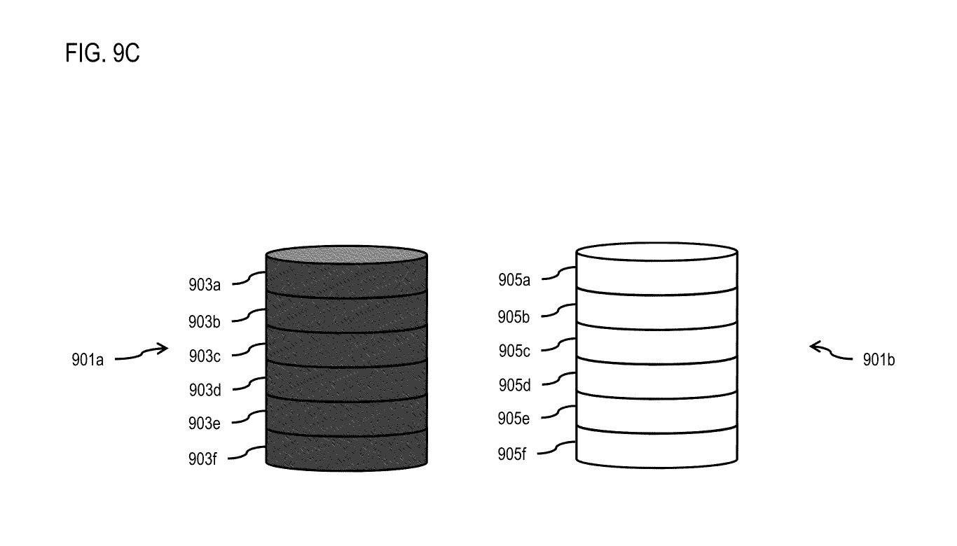

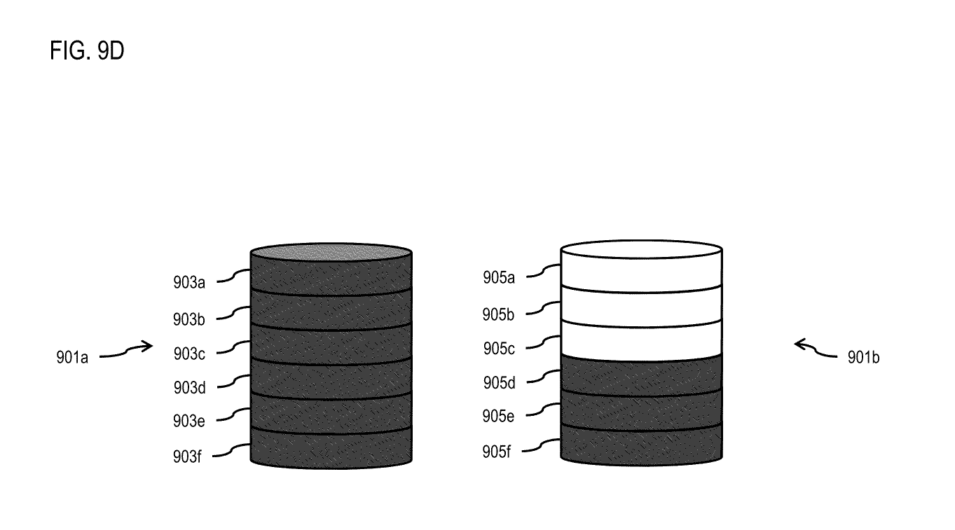

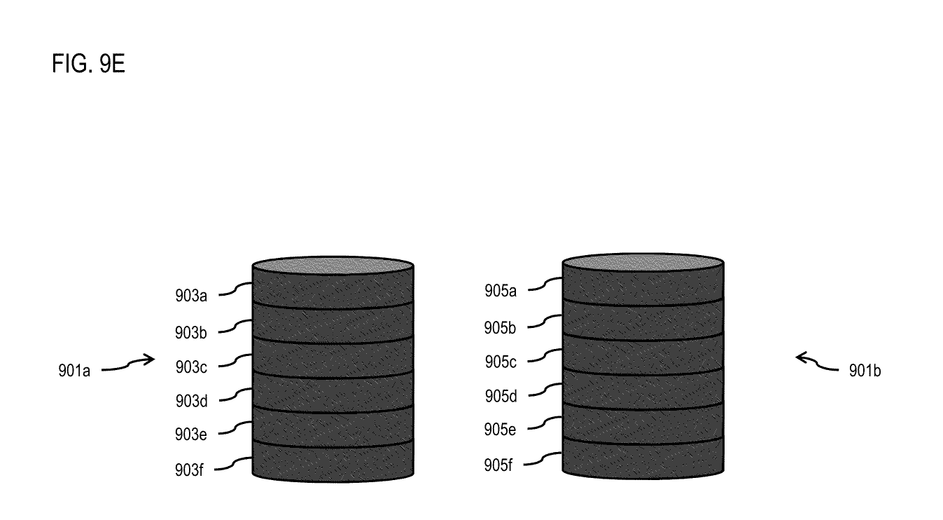

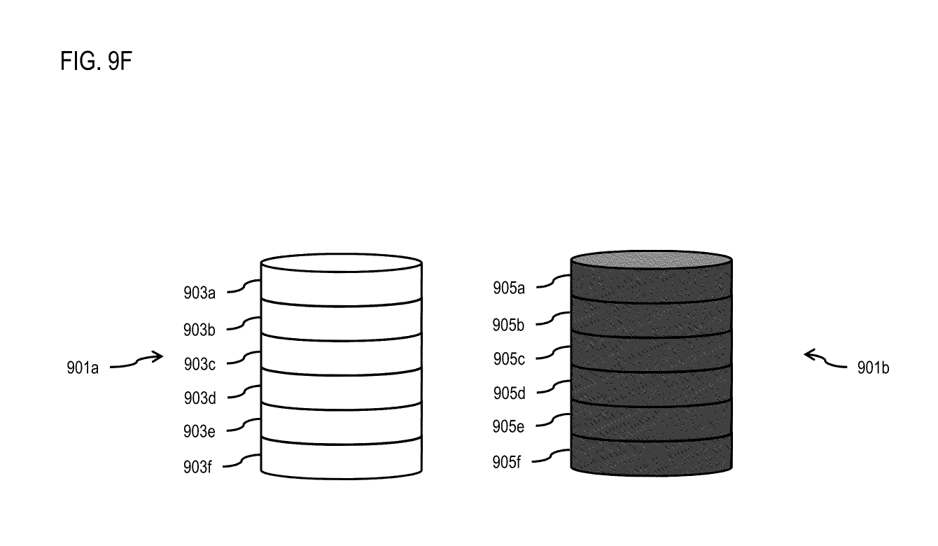

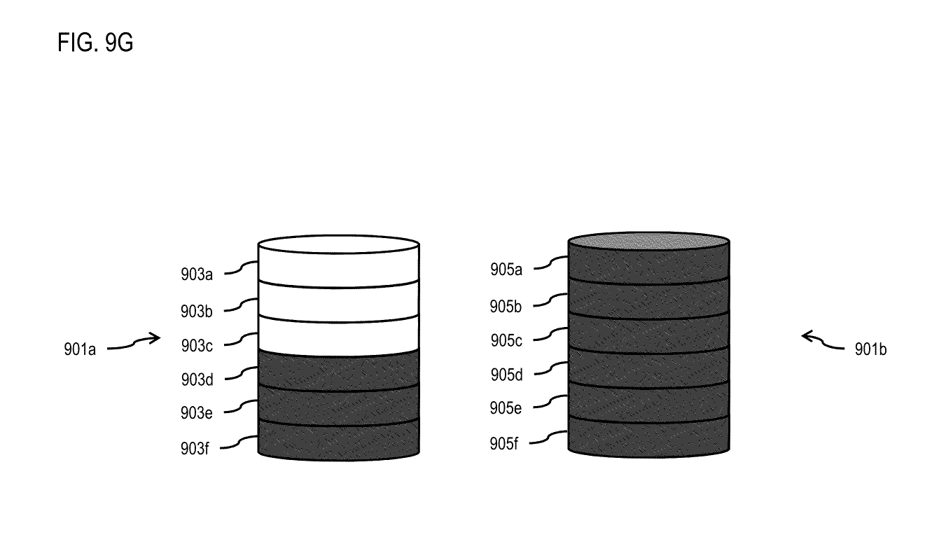

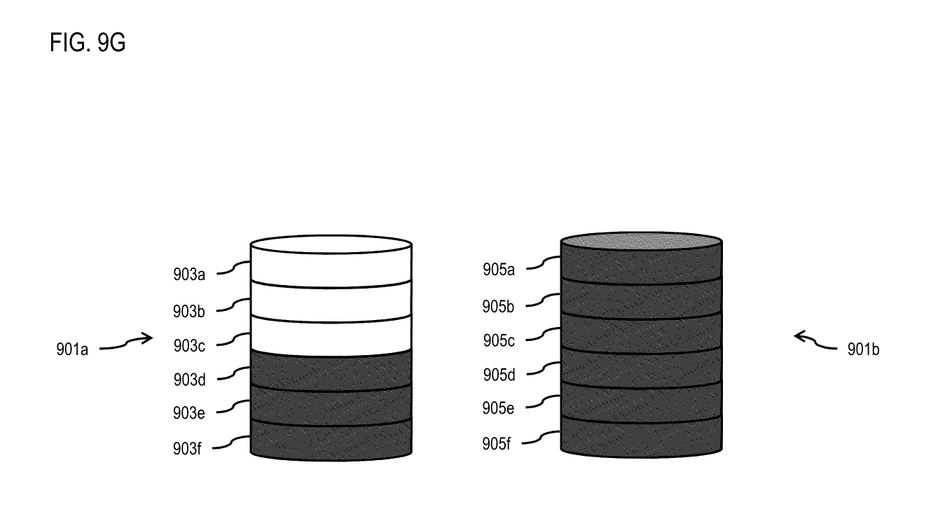

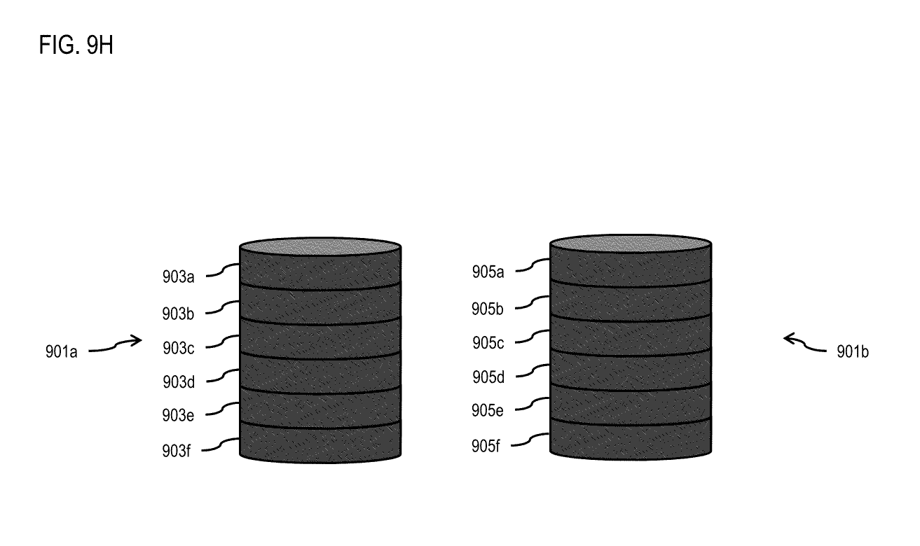

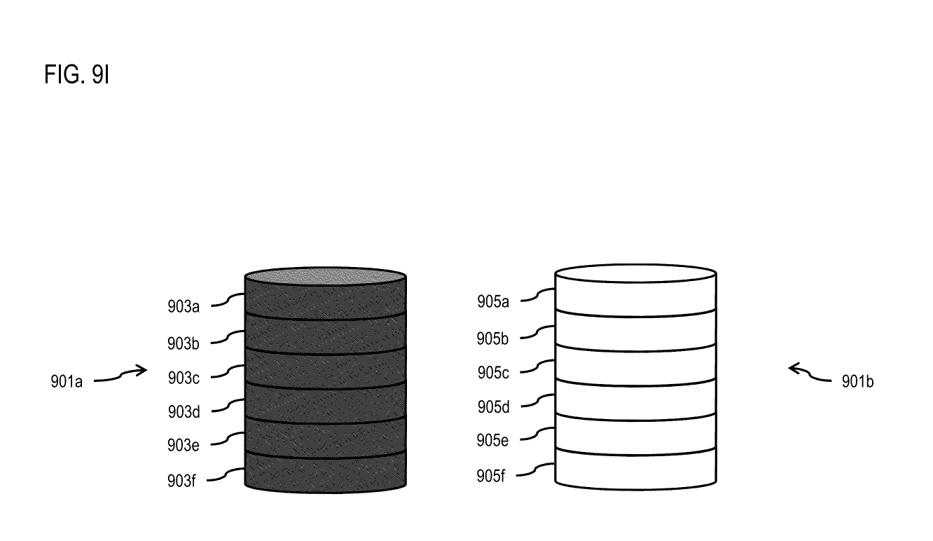

FIGS. 9A-9I are diagrams of exemplary probabilistic data structures 901a and 901b (e.g., Bloom filters) utilized in detecting duplicate messages, according to one embodiment. Each of the probabilistic data structures 901a and 901b may have a threshold capacity that is based on a number of messages that can be represented. In one embodiment, the threshold capacity is based on the ability to detect messages that are definitely not within the set (e.g., non-duplicates), while controlling the probability that a false indication of duplicate messages is generated (e.g., a determination that a message is within the set that is wrong). Accordingly, the threshold capacity may be less than a maximum capacity, where the maximum capacity would generate more than a desired amount of false indications. To illustrate the capacity, the probabilistic data structure 901a includes six entries 903a-903f to illustrate that the probabilistic data structures 901a has a threshold capacity of representations of six messages. Similarly, the probabilistic data structure 901b includes six entries 905a-905f to illustrate that the probabilistic data structures 901b has a threshold capacity of representations of six messages.

As illustrated in FIG. 9A, initially the probabilistic data structures 901a and 901b may be empty, such as prior to having one or more messages represented within the structures. Adverting to FIG. 9B, first representations of messages may be associated with probabilistic data structure 901a. Accordingly, entries 903d-903f are shaded representing probabilistic data structure 901a currently represents three messages. As probabilistic data structure 901a includes representations of messages, probabilistic data structure 901a is used for determining duplicate messages. However, whether the first representations of messages are associated with probabilistic data structure 901a or probabilistic data structure 901b is arbitrary.

More and more messages are then represented by probabilistic data structure 901a until the probabilistic data structure 901a reaches the threshold capacity, e.g., representations of six messages, as illustrated by all entries 903a-903f being shaded in FIG. 9C. After probabilistic data structure 901a reaches the threshold capacity, probabilistic data structure 901b subsequently stores representations of additional messages, as illustrated by the shaded entries 905d-905f of probabilistic data structure 901b in FIG. 9D. As illustrated, probabilistic data structure 901b includes three representations of messages as indicated by the shaded entries 905d-905f. As both probabilistic data structures 901a and 901b include representations of messages, both probabilistic data structures 901a and 901b are used for detecting duplicate messages.

Subsequently, as more messages are represented within the probabilistic data structure 901b, the probabilistic data structure 901b may reach the threshold capacity, as illustrated in FIG. 9E by the shaded entries 905a-905f. While both probabilistic data structures 901a and 901b are at their respective threshold capacities, both probabilistic data structures 901a and 901b are used for determining duplicate messages.

When another message needs to be represented within the probabilistic data structures 901a and 901b, such as when a new push notification is initially received at the UE 101, in one embodiment, probabilistic data structure 901a is cleared because probabilistic data structure 901a contains representations of the oldest messages, as illustrated in FIG. 9F. However, in one embodiment, whether probabilistic data structure 901a or probabilistic data structure 901b is cleared is arbitrary. Moreover, in embodiments that include more than two probabilistic data structures, the probabilistic data structure that contains representations of the oldest messages can be cleared such that the probabilistic data structure that is cleared sequentially changes among all of the probabilistic data structures, or an arbitrary one or more probabilistic data structures may be cleared. For example, two probabilistic data structures may be cleared in an embodiment containing four probabilistic data structures. Further, despite probabilistic data structure 901a being cleared, probabilistic data structure 901b may still be used for detecting duplicate messages.

As illustrated in FIG. 9G, a representation of the other message, along with representations of additional messages, may then be stored in probabilistic data structure 901a, as illustrated by the shaded entries 903d-903f.

Subsequently, as more messages are represented within the probabilistic data structure 901a, the probabilistic data structure 901a may again reach the threshold capacity, as illustrated in FIG. 9H by the shaded entries 903a-903f. Subsequently, when another message needs to be represented within the probabilistic data structures 901a and 901b, in one embodiment, probabilistic data structure 901b is then cleared because probabilistic data structure 901b now contains representations of the oldest messages, as illustrated in FIG. 9I. Thus, the clearing between probabilistic data structures 901a and 901b can alternate depending on which probabilistic data structure contains the oldest representations of messages. However, in one embodiment, whether probabilistic data structure 901b or probabilistic data structure 901a is cleared is arbitrary. Moreover, in embodiments that include more than two probabilistic data structures, the probabilistic data structure that contains representations of the oldest messages can be cleared such that the probabilistic data structure that is cleared sequentially changes among all of the probabilistic data structures, or an arbitrary one or more probabilistic data structures may be cleared. For example, two probabilistic data structures may be cleared in an embodiment containing four probabilistic data structures. Further, despite probabilistic data structure 901b being cleared, probabilistic data structure 901a may still be used for detecting duplicate messages.

The above visualization may thus repeat and revert back to FIG. 9D such that representations of additional messages are stored in probabilistic data structure 901b. Based on the foregoing procedure, at least one probabilistic data structure contains representations of messages that can be used for detecting duplicate messages at any one time.

The processes described herein for detecting duplicate messages may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

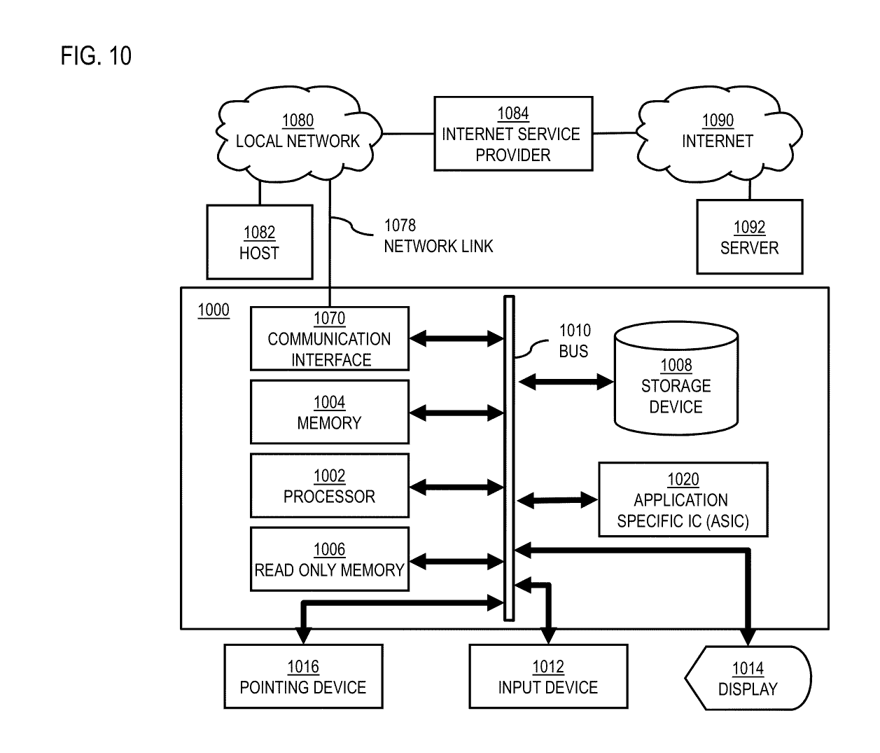

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 10 can deploy the illustrated hardware and components of system 1000. Computer system 1000 is programmed (e.g., via computer program code or instructions) to detect duplicate messages as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of detecting duplicate messages.

A bus 1010 includes one or more parallel conductors of information so that information is transferred quickly among devices coupled to the bus 1010. One or more processors 1002 for processing information are coupled with the bus 1010.

A processor (or multiple processors) 1002 performs a set of operations on information as specified by computer program code related to detecting duplicate messages. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1000 also includes a memory 1004 coupled to bus 1010. The memory 1004, such as a random access memory (RAM) or any other dynamic storage device, stores information including processor instructions for detecting duplicate messages. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or any other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for detecting duplicate messages, is provided to the bus 1010 for use by the processor from an external input device 1012, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT), a liquid crystal display (LCD), a light emitting diode (LED) display, an organic LED (OLED) display, a plasma screen, or a printer for presenting text or images, and a pointing device 1016, such as a mouse, a trackball, cursor direction keys, or a motion sensor, for controlling a position of a small cursor image presented on the display 1014 and issuing commands associated with graphical elements presented on the display 1014. In some embodiments, for example, in embodiments in which the computer system 1000 performs all functions automatically without human input, one or more of external input device 1012, display device 1014 and pointing device 1016 is omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of ASICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 105 for detecting duplicate messages at the UE 101.

The term “computer-readable medium” as used herein refers to any medium that participates in providing information to processor 1002, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1008. Volatile media include, for example, dynamic memory 1004. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 1000 in response to processor 1002 executing one or more sequences of one or more processor instructions contained in memory 1004. Such instructions, also called computer instructions, software and program code, may be read into memory 1004 from another computer-readable medium such as storage device 1008 or network link 1078. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server host 1092 transmits program code for a particular application, requested by a message sent from computer 1000, through Internet 1090, ISP equipment 1084, local network 1080 and communications interface 1070. The received code may be executed by processor 1002 as it is received, or may be stored in memory 1004 or in storage device 1008 or any other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

FIG. 11 illustrates a chip set or chip 1100 upon which an embodiment of the invention may be implemented. Chip set 1100 is programmed to detect duplicate messages as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of providing user interface navigation information associated with the availability of functions. Chip set or chip 1100, or a portion thereof, constitutes a means for performing one or more steps of detecting duplicate messages.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1100 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to detect duplicate messages The memory 1105 also stores the data associated with or generated by the execution of the inventive steps.

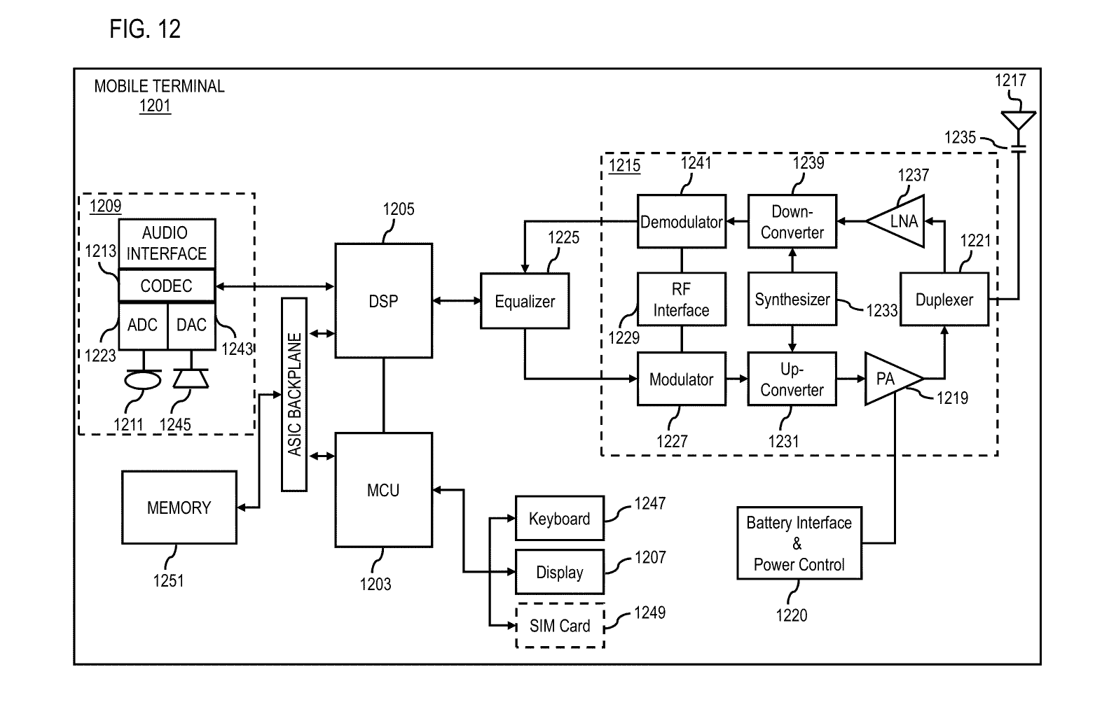

FIG. 12 is a diagram of exemplary components of a mobile terminal (e.g., handset) for communications, which is capable of operating in the system of FIG. 1, according to one embodiment. In some embodiments, mobile terminal 1201, or a portion thereof, constitutes a means for performing one or more steps of detecting duplicate messages. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of detecting duplicate messages. The display 1207 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203 which can be implemented as a Central Processing Unit (CPU).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 to detect duplicate messages. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a representing of one or more messages in two or more probabilistic data structures; and
an alternating clearing of the two or more probabilistic data structures as respective data structures are filled with the one or more messages to respective thresholds,
wherein the two or more probabilistic data structures facilitate determination of one or more duplicates among the one or more messages.

2. A method of claim 1, wherein the alternating clearing is alternating clearing between at least one of the two or more probabilistic data structures as at least another of the two or more probabilistic data structures is filled to the respective threshold.

3. A method of claim 2, wherein the respective threshold is based on a number of the one or more messages that are represented in the at least another of the two or more probabilistic data structures.

4. A method of claim 2, wherein the (1) data and/or (2) information and/or (3) at least one signal are further based, at least in part, on the following:
a populating of the at least one of the two or more probabilistic data structures after the clearing.

5. A method of claim 1, wherein the (1) data and/or (2) information and/or (3) at least one signal are further based, at least in part, on the following:
a respective counting of the one or more messages represented in the two or more probabilistic data structures.

6. A method of claim 1, wherein the (1) data and/or (2) information and/or (3) at least one signal are further based, at least in part, on the following:
one or more identifiers associated with the one or more messages; and
a processing of the one or more identifiers with respect to one or more hash functions of the two or more probabilistic data structures to cause, at least in part, the representing of the one or more messages.

7. A method of claim 6, wherein the (1) data and/or (2) information and/or (3) at least one signal are further based, at least in part, on the following:
at least one identifier associated with at least another message; and
a processing of the at least one identifier with respect to the one or more hash functions associated with the two or more probabilistic data structures to determine whether the at least another message is a duplicate of the one or more messages.

8. A method of claim 1, wherein the (1) data and/or (2) information and/or (3) at least one signal are further based, at least in part, on the following:
a deleting of the one or more duplicates upon determination of the one or more duplicates.

9. A method of claim 1, wherein the two or more probabilistic data structures are Bloom filters.

10. A method of claim 1, wherein the one or more notifications are associated with one or more emails, one or more short message service messages, one or more multimedia messaging service messages, or a combination thereof.

11. An apparatus comprising:
at least one processor; and
at least one memory including computer program code for one or more programs,
the at least one memory and the computer program code configured to, with the at least one processor, cause the apparatus to perform at least the following,
cause, at least in part, a representing of one or more messages in two or more probabilistic data structures; and
cause, at least in part, an alternating clearing of the two or more probabilistic data structures as respective probabilistic data structures are filled with the one or more messages to respective thresholds,
wherein the two or more probabilistic data structures facilitate determination of one or more duplicates among the one or more messages.

12. An apparatus of claim 11, wherein the alternating clearing is alternating clearing between at least one of the two or more probabilistic data structures as at least another of the two or more probabilistic data structures is filled to the respective threshold.

13. An apparatus of claim 12, wherein the respective threshold is based on a number of the one or more messages that are represented in the at least another of the two or more probabilistic data structures.

14. An apparatus of claim 12, wherein the apparatus is further caused to:
cause, at least in part, a populating of the at least one of the two or more probabilistic data structures after the clearing.

15. An apparatus of claim 11, wherein the apparatus is further caused to:
cause, at least in part, a respective counting of the one or more messages represented in the two or more probabilistic data structures.

16. An apparatus of claim 11, wherein the apparatus is further caused to:
determine one or more identifiers associated with the one or more messages; and
process and/or facilitate a processing of the one or more identifiers with respect to one or more hash functions of the two or more probabilistic data structures to cause, at least in part, the representing of the one or more messages.

17. An apparatus of claim 16, wherein the apparatus is further caused to:
determine at least one identifier associated with at least another message; and
process and/or facilitate a processing of the at least one identifier with respect to the one or more hash functions associated with the two or more probabilistic data structures to determine whether the at least another message is a duplicate of the one or more messages.

18. An apparatus of claim 11, wherein the apparatus is further caused to:
cause, at least in part, a deleting of the one or more duplicates upon determination of the one or more duplicates.

19. An apparatus of claim 11, wherein the two or more probabilistic data structures are Bloom filters.

20. An apparatus of claim 11, wherein the one or more notifications are associated with one or more emails, one or more short message service messages, one or more multimedia messaging service messages, or a combination thereof.

21.-48. (canceled)
